(19) United States
(12) Patent Application Publication
(10) Pub. No.: US 2006/0004902 A1
(43) Pub. Date: Jan. 5, 2006

(54) Reconfigurable circuit with programmable split adder

(76) Inventors: Siva Simanapalli, Santa Clara, CA (US); Ernest T. Tsui, Cupertino, CA (US); Anthony L. Chun, Los Altos, CA (US)

Correspondence Address: LeMoine Patent Services, PLLC;PortfolioIP, P.O. Box 52050, Minneapolis, MN, 55402, US

(21) Appl. No.: 10/881,334

(22) Filed: Jun. 30, 2004

(51) Int. Cl. G06F 7/50

(52) U.S. Cl. 708/670

(57) ABSTRACT

A reconfigurable circuit includes a multiply-accumulator with a programmable pre-adder and also includes a scramble sequence generator. The scramble sequence generator may provide a despreading sequence to control inputs on the programmable pre-adder.

### FIELD

The present invention relates generally to reconfigurable circuits, and more specifically to programming reconfigurable circuits.

### BACKGROUND

Some integrated circuits are programmable or configurable. Examples include microprocessors and field programmable gate arrays. As programmable and configurable integrated circuits become more complex, the tasks of programming and configuring them also become more complex.

### BRIEF DESCRIPTION OF THE DRAWINGS

FIG. 1 shows a block diagram of a reconfigurable circuit;

FIG. 2 shows a diagram of a processing element;

FIG. 3 shows a configured processing element;

FIGS. 4 and 5 show programmable adder circuits in accordance with various embodiments of the present invention;

FIGS. 6 and 7 show flowcharts in accordance with various embodiments of the present invention; and

FIG. 8 shows a diagram of an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

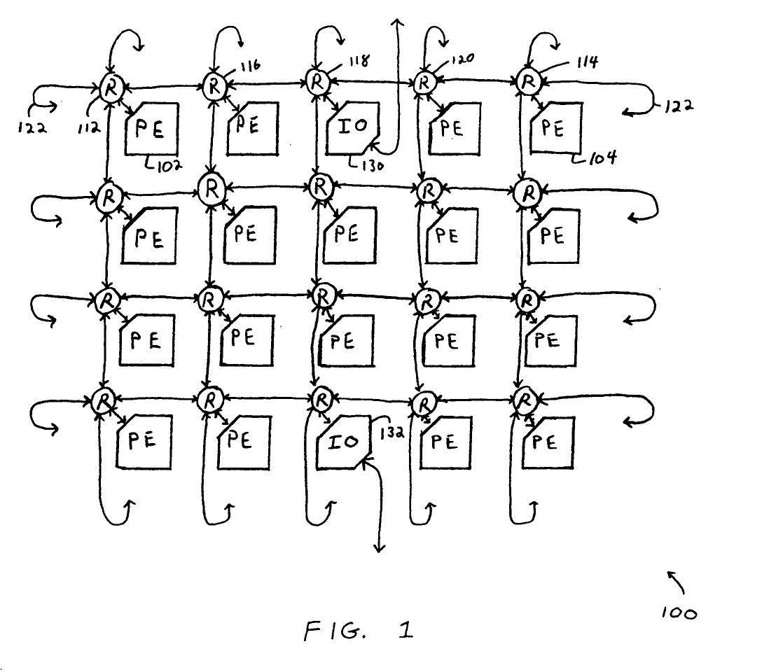

FIG. 1 shows a block diagram of a reconfigurable circuit. Reconfigurable circuit 100 includes a plurality of processing elements (PEs) and a plurality of interconnected routers (Rs). In some embodiments, each PE is coupled to a single router, and the routers are coupled together. For example, as shown in FIG. 1, PE 102 is coupled to router 112, and PE 104 is coupled to router 114. Also for example, as shown in FIG. 1, routers 112 and 114 are coupled together through routers 116, 118, and 120, and are also coupled together directly by interconnect 122 (shown at left of R 112 and at right of R 114). The various routers (and PEs) in reconfigurable circuit 100 are arranged in rows and columns with nearest-neighbor interconnects, such that the rows and columns of routers are interconnected in a mesh topology. In some embodiments, each router is coupled to a single PE, and in other embodiments, each router is coupled to more than one PE.

In some embodiments of the present invention, configurable circuit 100 may have a “heterogeneous architecture” that includes various different types of PEs. For example, PE 102 may include a programmable logic array that may be configured to perform a particular logic function, while PE 104 may include a processor core that may be programmed with machine instructions. In some embodiments, some PEs may implement various types of “micro-coded accelerators” (MCAs). MCAs may be employed to accelerate particular functions, such as filtering data, performing digital signal processing (DSP) tasks, or convolutional encoding or decoding. In general, any number of PEs with a wide variety of architectures may be included within configurable circuit 100.

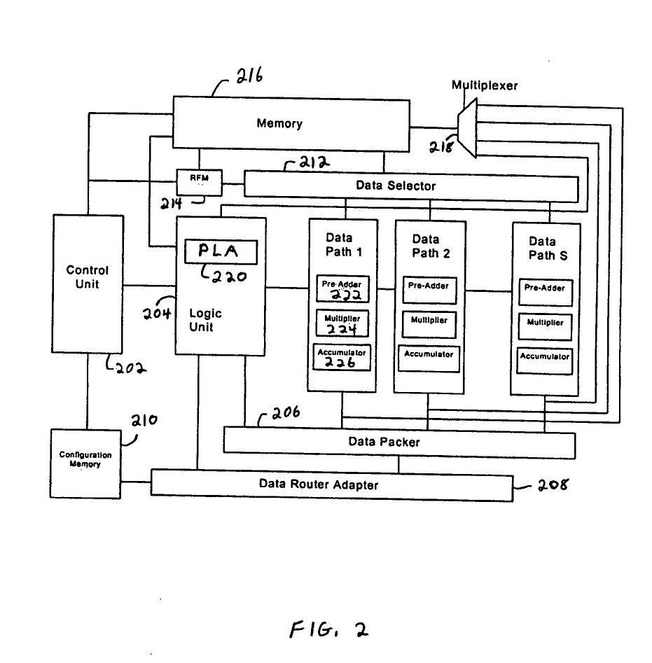

In some embodiments, one or more PEs may be implemented as a filter micro-coded accelerator (FMCA). A FMCA may be configured to perform computationally-intensive communications signal processing tasks. A FMCA may be configured to perform a variety of functions, such as operating as a resampling filter, digital filter, channel estimator, decimation filter, adaptive LMS equalizer, fast Fourier transformer, frequency corrector, rake receiver, spread spectrum uplink and downlink spreader/despreader, preamble detector, transmit filter, and other DSP numerically intensive functions based on a multiply/accumulate structure. An example embodiment of a FMCA is described further below with reference to FIG. 2.

As shown in FIG. 1, configurable circuit 100 includes input/output (10) elements 130 and 132. Input/output elements 130 and 132 may be used by configurable circuit 100 to communicate with other circuits. For example, IO element 130 may be used to communicate with a host processor, and IO element 132 may be used to communicate with an analog front end such as a radio frequency (RF) receiver or transmitter. Any number of IO elements may be included in configurable circuit 100, and their architectures may vary widely. Like PEs, IOs may be configurable or programmable, and may have differing levels of configurability based on their underlying architectures.

In some embodiments, each PE is individually configurable. For example, PE 102 may be configured by loading a table of values that defines a logic function, and PE 104 may be programmed by loading a machine program to be executed by PE 104. In some embodiments, a PE may be configured or programmed to perform multiple functions. For example, a PE may perform multiple filtering functions or multiple coding or decoding functions. In some embodiments, multiple functions may operate in parallel in a PE.

In some embodiments, the routers communicate with each other and with PEs using packets of information. For example, if PE 102 has information to be sent to PE 104, it may send a packet of data to router 112, which routes the packet to router 114 for delivery to PE 104. Packets may include control information or data, and may be of any size. In embodiments that utilize packets, configurable circuit 100 may be referred to as a “packet-based heterogeneous reconfigurable architecture.”

Configurable circuit 100 may be configured by receiving configuration packets through an IO element. For example, IO element 130 may receive configuration packets that include configuration information for various PEs and IOs, and the configuration packets may be routed to the appropriate elements. Configurable circuit 100 may also be configured by receiving configuration information through a dedicated programming interface. For example, a serial interface such as a serial scan chain may be utilized to program configurable circuit 100.

Various method embodiments of the present invention may be performed by a processing element within configurable circuit 100. For example, various methods described below with reference to later figures may be performed by a processor within configurable circuit 100.

Configurable circuit 100 may have many uses. For example, configurable circuit 100 may be configured to instantiate particular physical layer (PHY) implementations in communications systems, or to instantiate particular media access control layer (MAC) implementations in communications systems. For example, configurable circuit 100 may be configured to operate in compliance with any of a variety of communication protocols, such as IEEE 802.11, IEEE 802.16, General Packet Radio Service (GPRS), Enhanced GPRS (EGPRS), Bluetooth, Ultra Wideband (UWB), third generation cellular (3GPP) wideband code division multiple access (WCDMA) spread spectrum, fourth generation cellular (4G), ITU G.992.1 Asymmetrical Digital Subscriber Line (ADSL), ADSL2+, and so forth.

In some embodiments, multiple configurations for configurable circuit 100 may exist, and changing from one configuration to another may allow a communications system to quickly switch from one PHY to another, one MAC to another, or between any combination of multiple configurations.

In some embodiments, configurable circuit 100 is part of an integrated circuit. In some of these embodiments, configurable circuit 100 is included on an integrated circuit die that includes circuitry other than configurable circuit 100. For example, configurable circuit 100 may be included on an integrated circuit die with a processor, memory, or any other suitable circuit. In some embodiments, configurable circuit 100 coexists with radio frequency (RF) circuits on the same integrated circuit die to increase the level of integration of a communications device. Further, in some embodiments, configurable circuit 100 spans multiple integrated circuit dies.

FIG. 2 shows a diagram of a processing element. FMCA 200 represents an example embodiment of a microcoded accelerator PE. In some embodiments, FMCA 200 may be configured to perform computationally-intensive communications signal processing tasks for various communications protocols, such as IEEE 802.11, IEEE 802.16, GPRS, EGPRS, Bluetooth, UWB, 3GPP, WCDMA, 4G, ITU G.992.1 ADSL and ADSL2+, and so forth. The foregoing list of possible protocols is provided as an example, only, and the various embodiments of the present invention are not so limited.

As shown in FIG. 2, FMCA 200 includes control unit 202, logic unit 204, data path execution units I-N, data packer 206, data router adapter 208, configuration memory 210, data selector 212, register file module (RFM) 214, memory unit 216, and multiplexer (MUX) 218. Logic unit 204 may further include a programmable logic array (PLA) 220. Although FIG. 2 shows a limited number of elements within FMCA 200, the various embodiments of the invention are not so limited. Any number of elements may be incorporated in FMCA 200 without departing from the scope of the present invention.

In some embodiments, data router adapter 208 operates as a PE-independent interface to an external data router, such as router 116 (FIG. 1). Data router adapter 208 may receive data packets from a data router, buffer them, examine packet headers, and dispatch packets based on packet type. For example, data router adapter 208 may send processing data packets to memory 216, and configuration and read request packets to configuration memory 210. Data router adapter 208 may also provide an output buffer to assemble data packets for transmission. When the output buffer contains a fully assembled packet, data router adapter 208 examines the header for the destination PE, and may route the packet outside FMCA 200 if FMCA 200 is not the destination PE.

In some embodiments, memory 216 includes a multi-ported data memory to store incoming data for processing (X data), coefficients and constants (Y data) and data generated by the Arithmetic Unit and Logic Unit (Z data). The ports on memory 216 may include the Z read for accessing data in memory, the W data write port for writing incoming data packets, X and Y read ports for reading data and coefficients during function execution, and the Z write port for storing configuration data prior to function execution and for writing data during execution by the execution units, such as logic unit 204 and data paths 1-S. In some embodiments, data selector 212 receives X and Y data reads from memory 216 plus data from RFM 214, and distributes the data to the multiple data paths 1-S and logic unit inputs. In some embodiments, RFM 214 may be configured to store previously read X data during function execution when multiple read cycles are needed to provide data for calculations.

In some embodiments, logic unit 204 may be configured to perform scalar arithmetic operations. Logic unit 204 may also supply triggered function identifiers to control unit 202, as well as register status signals for handling data dependent branching of control operations. A function identifier may be an identifier used to uniquely identify a function to be executed by the execution units. A triggered function identifier may comprise a function identifier for a function having sufficient input data to begin function execution by the execution units.

In some embodiments, FMCA 200 includes a plurality of data path execution units, such as data paths 1-S, that may be configured to perform various arithmetic operations. For example, in some embodiments, FMCA 200 may comprise eight data path execution units. Each of data paths 1-S may include a multiply-accumulator (MACC) structure, and each MACC structure may include, for example, a pre-adder 222, multiplier 224 and accumulator 226. In these embodiments, data paths 1-S may be capable of two complex multiplies or eight real multiplies per clock cycle.

In some embodiments, the pre-adders for each of the MACCs are programmable split pre-adders. For example, pre-adders may receive control information from logic unit 204 that determines the operation of one or more pre-adders. In some embodiments, pre-adders may be programmed to perform 16 bit arithmetic on 16 bit operands, and may also be programmed as split adders that treat each 16 bit operand as two eight bit operands sharing an interconnect bus. In general, a programmable split pre-adder may be any number of bits in length, and may be divisible into any number of smaller adders. For example, in some embodiments, a programmable split pre-adder may be “b” bits in length, and may be split into two adders that are “b/2” in length.

Programmable pre-adders provide flexibility when programming FMCA 200 to perform different functions in support of various communications protocols. For example, a 16 bit pre-adder may be useful when performing Fast Fourier Transforms (FFT) butterfly operations in support of orthogonal frequency division multiplexing (OFDM) protocols. Also for example, a split adder may be useful when despreading a CDMA signal with real and imaginary components represented as eight bit numbers. Examples of a programmable pre-adder programmed for this purpose are described below with reference to later figures.

In some embodiments, control unit 202 may control execution for logic unit 204 and data paths 1-S. Control unit 202 may have a function queue to store function identifiers. The function queue stores triggered function identifiers received from logic unit 204 for functions that have received sufficient data to start function execution. Control unit 202 may read the function identifiers one at a time, and generates function control signals (FCS) as necessary to perform the desired function on a clock-by-clock basis.

Configuration memory 210 may store configuration information for control unit 202. For example, in some embodiments, configuration memory 210 may store programmable logic array (PLA) configurations and look up table (LUT) configurations for a plurality of different protocols.

Data packer 206 may receive processed input data from logic unit 204 and data paths 1-S, select the desired data, and output 32 bit words to a data router adapter 208 for transmit packet assembly.

In some embodiments, FMCA 200 may perform a set of function execution operations. For example, function execution may start with control unit 202 reading a function identifier from the function queue. As data is read from memory 216, control unit 202 issues control signals on a clock-by-clock basis as necessary to logic unit 204 and data paths 1-S. The set of control signals determines how the data is processed by logic unit 204 and data paths 1-S.

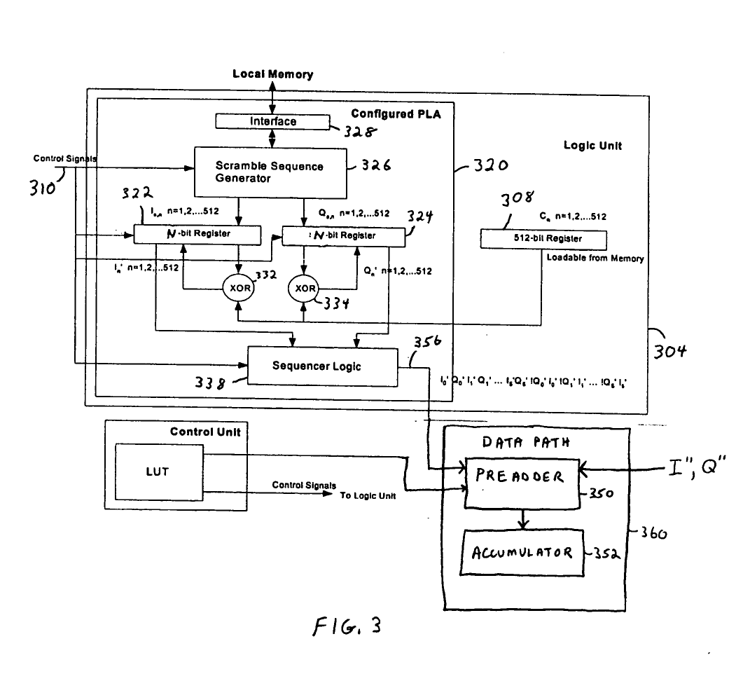

FIG. 3 shows a diagram of a configured processing element. FMCA 300 represents one possible configuration of an FMCA processing element. FIG. 3 emphasizes the configuration of logic unit 304, and of PLA 320 within logic unit 304. FMCA 300 is configured to perform despreading of a CDMA signal, such as a signal in compliance with a 3GPP standard. The operation of FMCA 300 and the various configured blocks shown in FIG. 3 are described in the context of the CDMA signal processing performed by FMCA 300.

In code division multiple access (CDMA) systems, channel spreading is a fundamental operation performed. It consists of two sub operations: channelization and scrambling. Channelization transforms every data symbol into a number of chips, thereby spreading the signal in frequency, and scrambling applies a scrambling code to the spread signal. Per symbol instant, the spread operation is given by
(I+jQ)C(Is+jQs) (1)
where (I+jQ) is the data symbol, C is the channel code, and (Is +jQs) is the scramble sequence at the chip rate. The channel code may include a 128 chip per symbol orthogonal variable spreading factor (OVSF) code such as those used for voice in 3GPP. In equations that follow, let
   C(Is+jQs)=I′+jQ′, (2)
keeping in mind that a real domain multiply, e.g., C(Is), is equivalent to a binary domain exclusive-or (C⊕Is). The spreading operation of equation (1), above, may be equivalently expressed as:
   (I+jQ)(I′+jQ′)=(II′−QQ′)+j(IQ′+QI′)=I″+jQ″. (3)

At a receiver, I_{k,n}″+jQ_{k,n}″ is the received kth symbol with chips n=1,2 . . . N, and I′+jQ′ is a known sequence (see eq. (2), above). The data symbol (I+jQ) may be recovered by performing the following operations:

$$\begin{matrix}{\sum }_{n ∈ N chips} {I}_{k , n}^{″} {I}_{n}^{′} + {Q}_{k , n}^{″} {Q}_{n}^{′} = {\sum }_{n} 2 {I}_{k} = ( 2 N ) {I}_{k} & ( 4 ) \\ {\sum }_{n ∈ N chips} - {I}_{k , n}^{″} {Q}_{n}^{′} + {Q}_{k , n}^{″} {I}_{n}^{′} = {\sum }_{n} 2 {Q}_{k} = ( 2 N ) {Q}_{k} & ( 5 )\end{matrix}$$

where the simplification I′I′=Q′Q′=1 (I′⊕I′=binary domain 0=real domain 1) has been used.

As shown in FIG. 3, FMCA 300 provides an efficient implementation of equations (4) and (5) where I″,Q″ are byte valued during receive processing. PLA 320 is configured to generate I′+jQ′ and provide it to pre-adder 350 in data path 360. Data path 360 then calculates the received I+jQ.

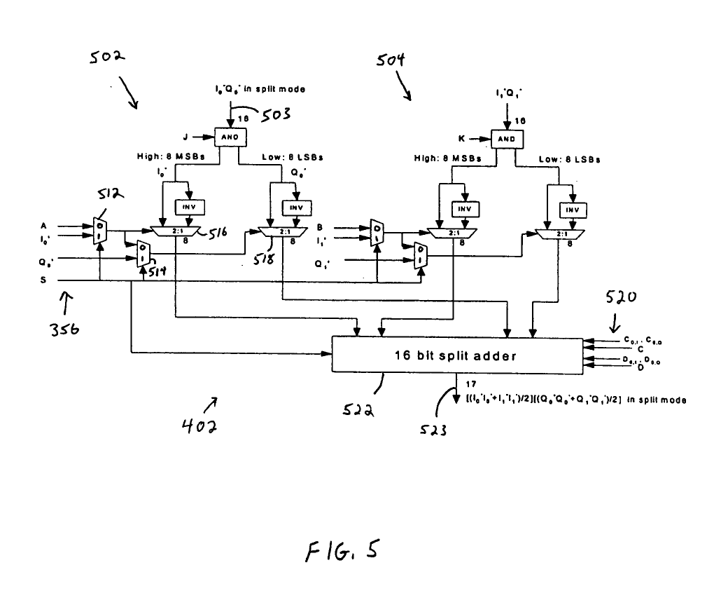

PLA 320 generates I′+jQ′ using scramble sequence generator 326, N-bit registers 322 and 324, and N-bit XOR operators 332 and 334, where N may be any number. N is shown as 512 in FIG. 3. Scramble sequence generator 326 may implement a pair of linear feedback shift registers (LFSR) to generate Is and Qs. The LFSRs in scramble sequence generator 326 may interface to the local memory using interface 328 for loading initial conditions and storing the current state when required. Register 322 receives Is from scramble sequence generator 326, and also receives the XORed combination of Is and the spreading code C provided by register 308 in logic unit 304. Further, Register 324 receives Qs from scramble sequence generator 326, and also receives the XORed combination of Qs and the spreading code C. Registers 322 and 324 provide I′+jQ′ (see equation (2), above) to sequencer logic 338. N bits of the outputs I′, Q′ are stored in registers 322 and 324 after N cycles. The control signals 310 may be generated in the PE by an instruction. Sequencer logic 338 derives control signals relating to I′+jQ′ to drive control inputs of pre-adder 350. These control signals are described in more detail below with reference to FIG. 5.

As shown in FIG. 3, I′+jQ′ and control signals for pre-adder 350 are generated in hardware. In some embodiments, I′+jQ′ and control signals for pre-adder 350 are generated in software. For example, in some embodiments, instructions executing on a PE may generate I′+jQ′ or they may be provided by the look up table (LUT) shown in FIG. 3.

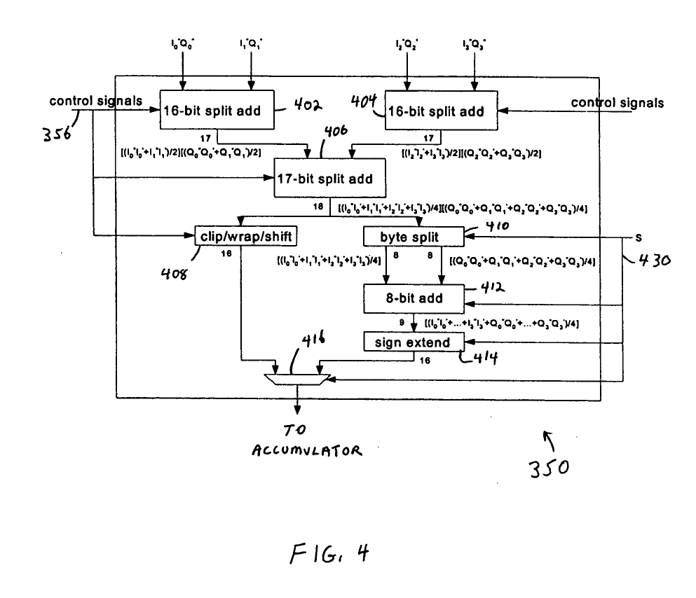

Referring to equation (4), above, in various embodiments of the present invention, pre-adder 350 performs I″I′+Q″Q′ for each chip or multiple chips, and accumulator 352 performs a summation over the number of chips per symbol to yield the real portion of the current symbol, I. Referring to equation (5), above, in various embodiments of the present invention, pre-adder 350 performs −I″Q′+Q″I′ for each chip, and accumulator 352 performs a summation over the number of chips per symbol to yield the imaginary portion of the current symbol, Q. The operation of the pre-adder is further described with reference to FIGS. 4 and 5, below.

FIG. 4 shows a programmable split pre-adder in accordance with various embodiments of the present invention. Pre-adder 350 includes 16 bit split adders 402 and 404, 17 bit split adder 406, clip/wrap/shift circuit 408, byte splitter 410, eight bit adder 412, sign extend circuit 414, and multiplexer 416. Split adders 402 and 404 are examples of programmable split adders that can perform 16 bit arithmetic on two 16 bit operands, or can perform eight bit arithmetic on two sets of eight bit operands. Further, based on the values of control signals, split adders 402 and 404 may perform multiplication operations (exclusive-or operations in the binary domain) by the interaction of the operands and the control signals, and may also provide a sum of products. This is described in more detail below with reference to FIG. 5.

As shown in FIG. 4, 16 bit split adder 402 receives two 16 bit inputs where each input includes an eight bit I″ operand concatenated with an eight bit Q″ operand. Split adder 402 also receives control signals 356, which are derived from I′ and Q′ by sequencer logic 338 (FIG. 3). When operating in split mode, split adder 402 sums the product of each I″ operand with the corresponding I′ operand and also sums the product of each Q″ operand with the corresponding Q′. This is shown at the output of split adder 402. The remaining split adders shown in FIG. 4 operate similarly, with the result that a sum of I″I′+Q″Q′ over four chips is available at the output of pre-adder 350.

Pre-adder 350 provides two paths after 17 bit split adder 406. The left path is for normal 16 bit pre-adder operation, and the right path is for split-adder operation. Pre-adder 350 operates in normal 16 bit operation or split adder operation based on the state of the “S” control signal on node 430.

As shown in FIG. 4, pre-adder 350 provides a sum of products over four chips when in split mode. If the input signal is spread with more than four chips per symbol, split adder 350 may provide the output signal to accumulator 352 (FIG. 3) to accumulate the sum of products further.

Pre-adder 350 is shown computing a portion of equation (4), above, to compute the real portion I of the current symbol. In some embodiments, pre-adder includes circuitry to compute the imaginary portion Q of the current symbol. In other embodiments, an additional data path having a pre-adder and accumulator is utilized to compute the imaginary portion Q of the current symbol. Further, in some embodiments, pre-adder 350 may be dynamically reconfigured to alternate between performing equation (4) and equation (5) to calculate both I and Q.

Although FIG. 4 shows a 16 bit programmable pre-adder that may be split for eight bit operation, this is not a limitation of the present invention. For example, the various programmable pre-adders of the present invention may be any length “b” and may be divisible into any number “g” of smaller units, each yielding “b/g” operation. In the example provided in FIG. 4, n=16 and g=2. Continuing with this example, the operation of the 16 bit split adders is now described with reference to FIG. 5, in which the operation of split adder 402 is described as it is programmed in FIG. 4.

FIG. 5 shows a programmable split adder circuit in accordance with various embodiments of the present invention. Split adder 402 includes input operand circuitry 502 and input operand circuitry 504. Input operand circuitry 502 includes data path multiplexers 516 and 518 and control path multiplexers 512 and 514. In operation, when in normal 16 bit operation (S=0) the 16 bit operand received on input 503 is conditionally negated by the operation of an add/subtract control signal A and a carry-in signal at 520. That is, when S=0 and A is asserted, the entire 16 bit operand is inverted by data path muxes 516 and 518, and a carry-in signal is provided at 520, thereby performing a two's-complement negation of the 16 bit operand on input 503.

When in split mode operation (S=1), the two eight bit operands concatenated on input 503 are separately multiplied against a control input value. Instead of A, I′ and Q′ are provided on the add/subtract control signal inputs. As a result, I″ is multiplied with I′, and Q″ is multiplied with Q′. The multiplication is provided between the eight bit values I″ and Q″ and the single bit values I′ and Q′ on a bit-wise basis by the exclusive-or operation provide by the data path multiplexers 516 and 518.

Adder 522 receives the S control signal and performs 16 bit arithmetic when in normal 16 bit operation, and performs two eight bit operations when in split mode operation. When in split mode operation, split adder 402 outputs two separate sums of products as shown on node 523.

FIGS. 4 and 5 have been described in the context of pre-adder 350 and accumulator 352 (FIG. 3) calculating the real portion of a symbol. A second pre-adder and accumulator from FMCA 300 may be utilized to compute the imaginary portion of the symbol in a like manner. Further, the operations described with reference to pre-adder 350 and accumulator 352 may be allocated among multiple pre-adders and accumulators in parallel, effectively increasing the data throughput.

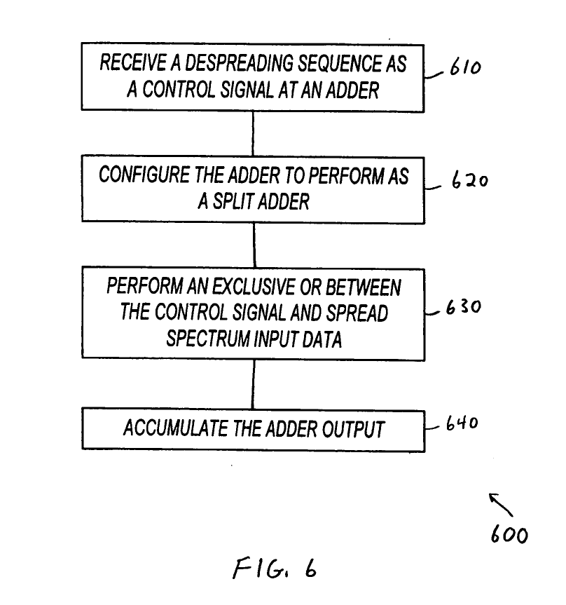

FIG. 6 shows a flowchart in accordance with various embodiments of the present invention. In some embodiments, method 600, or portions thereof, is performed by an electronic system, or a reconfigurable circuit. In other embodiments, all or a portion of method 600 is performed by a processing element within a reconfigurable circuit, embodiments of which are shown in the various figures. Method 600 is not limited by the particular type of apparatus or software element performing the method. The various actions in method 600 may be performed in the order presented, or may be performed in a different order. Further, in some embodiments, some actions listed in FIG. 6 are omitted from method 600.

Method 600 is shown beginning with block 610 in which a despreading sequence is received as a control signal at an adder. In some embodiments, this corresponds to the despreading sequence I′+Q′ on control input 356 (FIGS. 3,4). At 620, the adder is configured to perform as a split adder. The adder may be configured by asserting the S signal shown in FIGS. 4 and 5. The S signal may be asserted by a logic unit such as logic unit 204, or a control unit such as control unit 202 (FIG. 2).

At 630, an exclusive-or is performed between the control signal and spread spectrum input data as shown and described with reference to FIG. 5, and at 640, the adder output is accumulated. In some embodiments, the adder provides a sum of product over a number of chips. For example, embodiments represented by FIG. 5 sum products over four chips. Accumulating the adder output provides for a sum of products over more than four chips. For example, if 128 chips per symbol are used in the spreading sequence, the accumulator may accumulate 32 outputs from the adder.

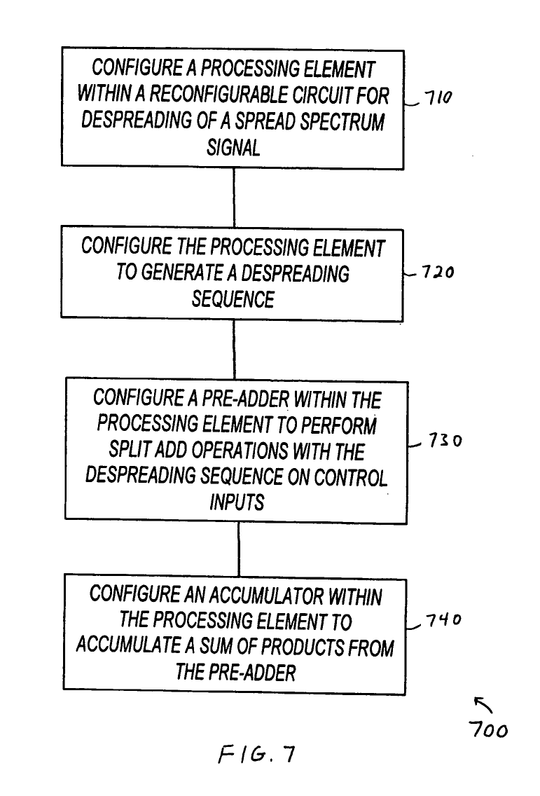

FIG. 7 shows a flowchart in accordance with various embodiments of the present invention. In some embodiments, method 700, or portions thereof, is performed by an electronic system, a control circuit, a processor, a configurable circuit, or a processing element (PE), embodiments of which are shown in the various figures. Method 700 is not limited by the particular type of apparatus or software element performing the method. The various actions in method 700 may be performed in the order presented, or may be performed in a different order. Further, in some embodiments, some actions listed in FIG. 7 are omitted from method 700.

Method 700 is shown beginning with block 710 in which a processing element is configured within a reconfigurable circuit for byte-based despreading of a spread spectrum signal. At 720, the processing element is configured to generate a spreading sequence. At 730, a pre-adder within the processing element is configured to perform split add operations with the spreading sequence on control inputs, and at 740, an accumulator within the processing element is configured to accumulate a sum of products output from the pre-adder.

In some embodiments, the configuration acts of method 700 correspond to configuring a FMCA with a programmable split pre-adder as shown in the previous figures. The configuration acts of method 700 may be performed by reading configuration packets and programming a reconfigurable circuit such as reconfigurable circuit 100 (FIG. 1). Further, an IO element within a reconfigurable circuit may perform the acts of method 700 by distributing configuring packets within a reconfigurable circuit.

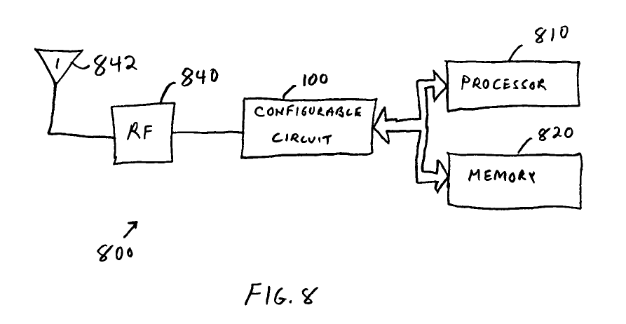

FIG. 8 shows a block diagram of an electronic system. System 800 includes processor 810, memory 820, configurable circuit 100, RF interface 840, and antenna 842. In some embodiments, system 800 may be a computer system to configure configurable circuit 100. For example, system 800 may be a personal computer, a workstation, a dedicated development station, or any other computing device capable of configuring configurable circuit 100. In other embodiments, system 800 may be an “end-use” system that utilizes configurable circuit 100 after it has been programmed with a particular configuration. Further, in some embodiments, system 800 may be a system capable of developing configurations as well as using them.

In some embodiments, processor 810 may be a processor that can perform various method embodiments of the present invention. For example, processor 810 may configure configurable circuit 100 by communicating with both memory 820 and configurable circuit 100. Configurations for configurable circuit 100 may be stored in memory 820, and processor 810 may read the configurations from memory 820 when configuring configurable circuit 100. Further, processor 210 may store one or more configurations in memory 820. Processor 810 represents any type of processor, including but not limited to, a microprocessor, a microcontroller, a digital signal processor, a personal computer, a workstation, or the like.

In some embodiments, system 800 may be a communications system, and processor 810 may be a computing device that performs various tasks within the communications system. For example, system 800 may be a system that provides wireless networking capabilities to a computer. In these embodiments, processor 810 may implement all or a portion of a device driver, or may implement all or part of a MAC. Also in these embodiments, configurable circuit 100 may implement one or more protocols for wireless network connectivity. In some embodiments, configurable circuit 100 may implement multiple protocols simultaneously, and in other embodiments, processor 810 may change the protocol in use by reconfiguring configurable circuit 100. Further, processor 810 may change the behavior of a protocol in use by reconfiguring a portion of configurable circuit 100.

Memory 820 represents an article that includes a machine readable medium. For example, memory 820 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by a machine such as processor 810. In some embodiments, memory 820 can store instructions for performing the execution of the various method embodiments of the present invention. Also in some embodiments, memory 820 can store one or more configurations for configurable circuit 100.

In operation of some embodiments, processor 810 reads instructions and data from memory 820 and performs actions in response thereto. For example, various method embodiments of the present invention may be performed by processor 810 while reading instructions from memory 820.

Antenna 842 may be either a directional antenna or an omni-directional antenna. For example, in some embodiments, antenna 842 may be an omni-directional antenna such as a dipole antenna, or a quarter-wave antenna. Also for example, in some embodiments, antenna 842 may be a directional antenna such as a parabolic dish antenna or a Yagi antenna. In some embodiments, antenna 842 is omitted, and in other embodiments, antenna 842 includes multiple antennas or multiple antenna elements.

In some embodiments, RF signals transmitted or received by antenna 842 may correspond to voice signals, data signals, or any combination thereof. For example, in some embodiments, configurable circuit 100 may implement a protocol for a wireless local area network interface, cellular phone interface, global positioning system (GPS) interface, or the like. In these various embodiments, RF interface 840 may operate at the appropriate frequency for the protocol implemented by configurable circuit 100. RF interface 840 may include any suitable components, including amplifiers, filters, mixers, and the like. In some embodiments, RF interface 840 is omitted.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising configuring a processing element within a reconfigurable circuit, the processing element having at least one accumulator and at least one configurable adder, wherein configuring includes configuring the configurable adder to be a split adder.

2. The method of claim 1 wherein configuring the processing element comprises configuring the processing element for byte-based despreading of a spread spectrum signal.

3. The method of claim 1 wherein configuring the processing element comprises configuring an adder of length b within the processing element to perform two separate arithmetic operations of length b/2.

4. The method of claim 1 wherein configuring the processing element comprises configuring the processing element to generate a scramble sequence to source to the split adder.

5. The method of claim 1 wherein configuring the processing element comprises configuring the processing element to provide the scramble sequence as control signals to the split adder to despread a spread spectrum signal.

6. A method comprising:
receiving as control signals at a split adder a sequence useful to despread a spread spectrum signal; and
performing an exclusive-or function between the control signals and received spread spectrum data using the split adder.

7. The method of claim 6 wherein receiving as control signals comprises receiving a despreading sequence as an add/subtract control signal at the split adder.

8. The method of claim 6 wherein the adder includes a b-bit input, and performing an exclusive-or function comprises using a lower b/2 bits of the b-bit input for one operation, and using an upper b/2 bits of the b-bit input for another operation.

9. The method of claim 6 further comprising accumulating an output from the split adder.

10. An article comprising:
a machine readable medium having a programmable element configuration stored thereon, that when applied to a programmable element causes a b-bit pre-adder to perform separate arithmetic operations of length b/2.

11. The article of claim 10 wherein the configuration, when applied to the programmable element, further causes the processing element to generate a despreading sequence to source to the pre-adder.

12. The article of claim 10 wherein the configuration, when applied to the programmable element, further causes the pre-adder to multiply two (b/2)-bit quantities with single bit quantities where the single bit quantities are input as control signals to the pre-adder.

13. A reconfigurable device including at least one multiply-accumulator having a programmable pre-adder configurable to perform arithmetic operations using a full length of the programmable pre-adder or to perform multiple operations using less than a full length of the programmable pre-adder.

14. The reconfigurable device of claim 13 further comprising a plurality of processing elements, wherein one of the plurality of processing elements includes the at least one multiply-accumulator.

15. The reconfigurable device of claim 14 wherein the one of the plurality of processing elements includes eight multiply-accumulators.

16. The reconfigurable device of claim 15 wherein each of the eight multiply-accumulators includes a programmable pre-adder.

17. The reconfigurable device of claim 13 further comprising a scramble sequence generator to provide a despreading sequence to control inputs on the programmable pre-adder.

18. The reconfigurable device of claim 13 wherein the programmable pre-adder is programmable to provide a sum of products when performing multiple operations using less than a full length of the programmable pre-adder.

19. The reconfigurable device of claim 18 wherein the products are products of eight bit operands on operand inputs and single bit operands on control inputs.

20. An apparatus comprising:
a plurality of heterogeneous configurable processing elements, wherein at least one of the processing elements includes a programmable pre-adder and a multiply-accumulator, wherein the programmable pre-adder is programmable to provide a sum of products or addition/subtraction.

21. The apparatus of claim 20 wherein the programmable pre-adder is programmable to perform b-bit arithmetic on two b-bit operands or to provide a sum of products between control inputs and four (b/2)-bit operands.

22. The apparatus of claim 21 wherein the at least one of the processing elements further includes a scramble sequence generator to provide a despreading sequence to the programmable pre-adder on the control inputs.

23. An electronic system comprising:
an antenna;
a radio frequency circuit to receive communications signals from the antenna; and
a reconfigurable device coupled to the radio frequency circuit, the reconfigurable device including at least one multiply-accumulator having a programmable pre-adder configurable to perform arithmetic operations using a full length of the programmable pre-adder or to perform multiple operations using less than a full length of the programmable pre-adder.

24. The electronic system of claim 23 further comprising a plurality of processing elements, wherein one of the plurality of processing elements includes the at least one multiply-accumulator.

25. The electronic system of claim 24 wherein the one of the plurality of processing elements includes eight multiply-accumulators.
